(19) United States
(12) Patent Application Publication
(10) Pub. No.: US 2022/0363950 A1
(43) Pub. Date: Nov. 17, 2022

(54) ADHESIVE TAPE STRIP WITH END LOCATOR

(71) Applicant: Cristina Crisan, Los Angeles, CA (US)

(72) Inventor: Cristina Crisan, Los Angeles, CA (US)

(21) Appl. No.: 17/651,998

(22) Filed: Feb. 22, 2022

Related U.S. Application Data
(60) Provisional application No. 63/187,670, filed on May 12, 2021.

(51) Int. Cl. C09J 7/20

(52) U.S. Cl. CPC C09J 7/20; C09J 2301/18

(57) ABSTRACT

An adhesive tape that provides a unique easy end locator which enables the user to find the terminal end of a tape. The adhesive tape is formed of multiple segments, where each segment includes a backing material that is the carrier of an adhesive layer, with perforations defined transversely across the longitudinal length of the backing to define multiple segments. Each segment has a unique, effortless end locator, a small area free of adhesive, located at the beginning of each segment, being an integral part of the backing material. The perforations may be made at predetermined length between a preceding segment and a subsequent. The predetermined length may be a uniform length. The final product may be carried on a core and formed into a roll. The tape can be used in fields where a predetermined length is desired. The lengths of multiple tapes can cover unlimited areas of use.

### CROSS-REFERENCE TO RELATED APPLICATION

This application claims the benefit of priority of U.S. provisional application No. 63/187,670 filed May 12, 2021, the contents of which are herein incorporated by reference.

### FIELD OF THE INVENTION

The present invention relates to adhesive tape, and more particularly to perforated adhesive tape strips with an easy end locator.

### BACKGROUND OF THE INVENTION

In everyday life, adhesive tapes are a necessity for various purposes. While the existing adhesive tapes, either with a finite or indefinite length, are many kinds and useful, they lack a practical end locator and can be difficult to locate the terminal end of a tape. Currently the methods most used to locate the end of a tape may require additional objects such as a paper clip, a toothpick, a pan as a tracer and so on.

The existing adhesive tapes that include a form of grasping area, incorporated in the construction, may have various supplemental non adhesive tabs placed along the length of the tape. This method requires additional steps in integrating the tabs into the manufacture of the product and removal of the tabs each time, that must be disposed after every use, makes it less practical.

Another similar form that involves a grasping zone, is the U.S. Pat. No. 5,878,971 which has one single perforated starter tab placed at the beginning of the adhesive tape with indeterminate length that facilitates the initial unwind. This method is not significantly better than a plain adhesive tape where a simple piece of paper can replace the perforated tab.

The U.S. Pat. No. 6,756,102 B1, provides an adhesive tape having serial segments with non-adherent gripping elements, as an improvement which eliminates the necessity for the supplemental tabs, as it says. Although this method also includes a gripping area, the final problem of being practical remains unsolved. Each segment/strip has two gripping elements, each located at one end, that may be unnecessary and not only a waste of tape, but the size of the gripping element is too big and takes too much space. The adhesive tape claims that an indeterminate length can be used as well, while technically can work, practically less so. A larger length is formed of more segments, not only would be too loaded, filled with too many griping elements but it has not enough force due to the perforation of each segment. The design is being too complex for an adhesive tape which can make it less effective and practical. In addition, the integration of the gripping elements into construction of the tape, requires more steps that add to the cost of manufacture.

Another problem with existing adhesive tapes may be the need to cut the tape to a desired length which involve either an external object such as scissors which sometimes can be out of reach or a cutting device/dispenser, sometimes incorporated in the role of tape. The dispenser requires consumption of additional materials that implicit increases the cost of manufacture, as well as additional space to store it, especially when more than one size is needed.

The existing adhesive tapes that are formed in a predetermined length may also use in its construction a protective layer that must be removed to expose the adhesive layer and apply the tape, which again requires the consumption of additional materials, asides from that, when tape is used, the protective release liner such as plastic or paper, must be disposed, which can make it less practical.

At the present time, although a number of adhesive tapes have emerged over time serving various purposes, no adhesive tape can provide an easy end locator that is effort less and practical. As can be seen, there is a need for a new component, an easy end locator that can enhance the current tapes in more ways.

### SUMMARY OF THE INVENTION

Broadly, the present invention provides an adhesive tape with an easy end locator. The end locator is not separated, it is an integral part of the backing material, a non-glued portion that is substantially free of adhesive at the beginning of each predetermined strip length making it very easy to locate the end of the tape and practical to use it. The size of non-glued portion is appropriately dimensioned to be easily grasped, either when the user is ready to dispense from a roll of adhesive tape or when removing the tape from a surface to which it has been applied. This roll of tape has also predetermined perforated strips lengths that eliminates the use of scissors or other cutting devices, without a need of a tape dispenser. This technique can be used in various fields where a predetermined length is desired. The various lengths of multiple tapes can cover unlimited areas of use.

In some versions, the perforation is defined at a uniform spacing along the longitudinal length of the backing material.

In some versions, the perforation is defined at a predetermined spacing along the longitudinal length of the backing material.

In some versions, the perforation is defined between a first strip and a subsequent strip.

In some versions, the easy end locator is defined a leading end each strip.

In some versions, the end locator is defined at a trailing end of each strip.

In some versions, a core is provided for retaining the backing material in a rolled configuration.

In other aspects of the invention, an adhesive tape is disclosed. The adhesive tape is formed of a single backing material having a longitudinal length and a width, an adhesive layer applied on the surface of the backing material of each strip, leaving a small portion of it free of adhesive which represents the end locator, followed by a transversely perforation across the longitudinal length of the backing material. The perforation defines the end and beginning of each of multiple strips.

These and other features, aspects and advantages of the present invention will become better understood with reference to the following drawings, description and claims.

### BRIEF DESCRIPTION OF THE DRAWINGS

FIG. 1 a side perspective view of a roll of adhesive tape strips with end locator according to aspects of the present invention.

FIG. 2 is a side perspective view of a roll of adhesive tape strips with end locator, showing an adhesive tape strip pulled from the roll.

FIG. 3 is a detail perspective view showing the end locator at a perforation.

FIG. 4 is a detail perspective view of an inner surface between adjoining adhesive tape strips.

FIG. 5 is a detail perspective view of an inner surface between adjoining adhesive tape strips, with a preceding strip separated from a subsequent strip along the perforation.

FIG. 6 is a top plan view of the inner surface between adjoining adhesive tape strips.

FIG. 7 is a detail side elevation view taken along line 7-7 of FIG. 6.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

In the present invention, an adhesive tape with an easy end locator is disclosed. More precisely an adhesive tape which enable you to easily locate the terminal end of the tape and has as well predetermined length strips that eliminate the use of scissors or other cutting devices, without the need of a tape dispenser. The adhesive tape strip consists of a backing material being the carrier of the adhesive layer which is applied on the approximately 98% of the surface of the backing material and the approximately remained 2% of the surface constitutes the end locator, a non-glued portion, free of adhesive at the end of each strip length, making it very easy to locate the end and practical to use it. This roll of tape also has predetermined perforated strip lengths that eliminates the use of scissors or other cutting devices, without a need of a tape dispenser. This technique can be used in many sizes for diverse projects.

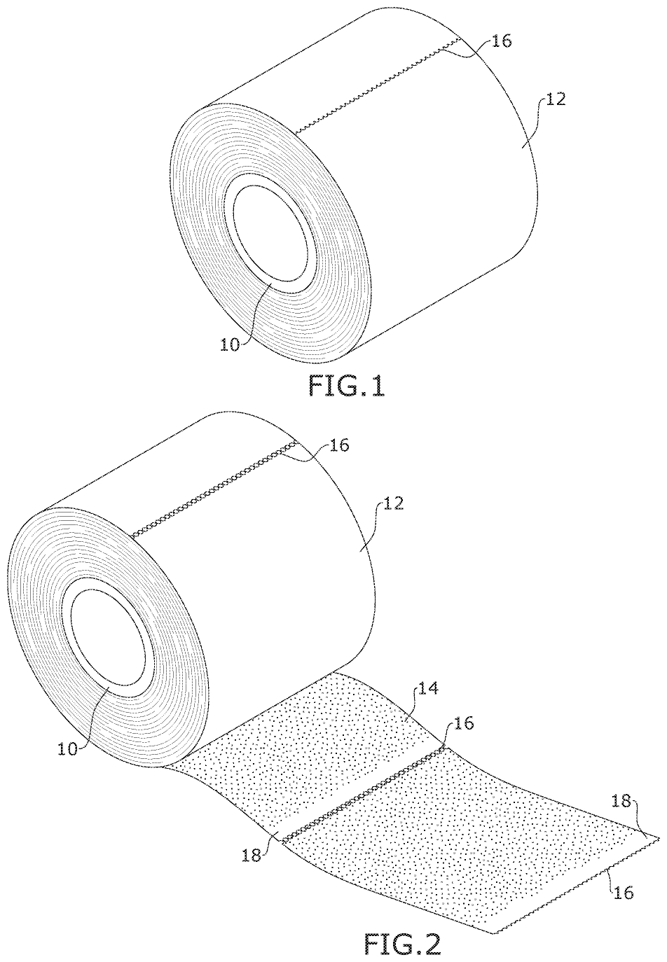

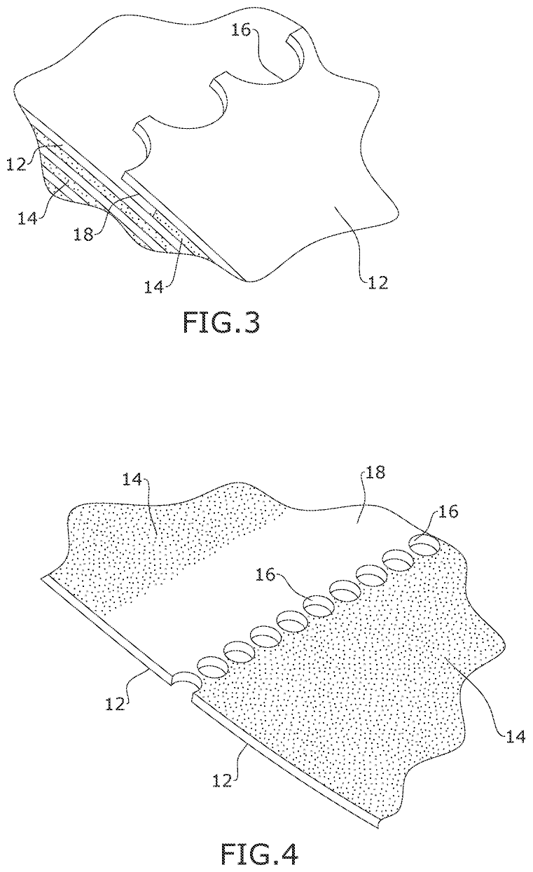

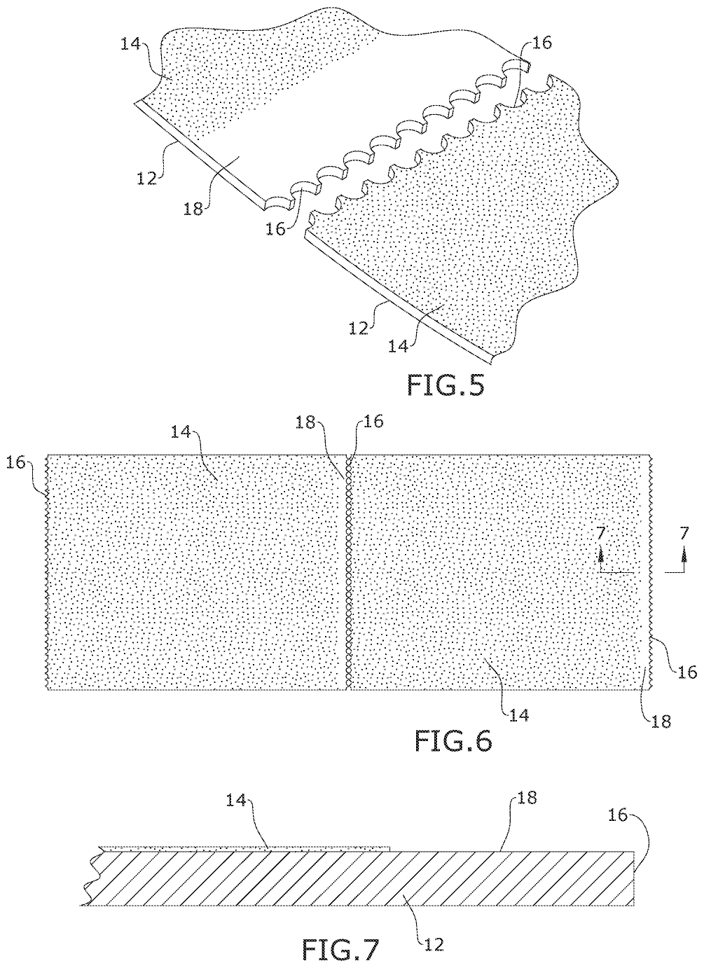

As seen in reference to the drawings of FIGS. 1-7, a non-limiting embodiment of the adhesive tape with a terminal end locator is shown. The adhesive tape with a terminal end locator may include multiple adhesive tape strips formed in a roll, with each of the multiple adhesive tape strips having a predetermined length.

Each of the adhesive tape strips have an end locator 18, a body 12, or backing material 12, and an adhesive layer 14 applied on an approximate 98% of the backing material 12. The multiple adhesive tape strips are joined and separable from each other at a perforation 16 extending transversely across a longitudinal length of the strip for easy separation of a preceding adhesive tape strip 12 from a subsequent adhesive tape strip 12.

In the version shown, the end locator 18 is shown at a leading end of the adhesive tape strip 12. The end locator 18, be an approximately 1/16 of an inch length of unglued space between each strip 12 size before the perforation 16 for easy end location.

The adhesive tape strips 12 are formed of a backing material that is used as an adhesive carrier. The backing may include different materials, such as cloth, foam, felt, polyester, PVC, vinyl, rubber, silicone, plastic film, metal foil like aluminum and so on.

The adhesive layer 14 may include any suitable adhesive, such as acrylic adhesives which provide excellent environmental resistance and provide a faster setting time than other adhesives. Epoxy resins exhibit high strength and low shrinkage. Rubber-based adhesives provide highly flexible bonds. Silicone adhesives and sealants have a high degree of flexibility and are resistant to very high temperatures. Polyurethane and Isocyanate adhesives provide more flexibility, impact, resistance, and durability.

The multiple adhesive tape strips may be carried on a core 10, which may be formed of any suitable material, such as a plastic or a paper tube 10. The substrate 12 and the adhesive 14 may be selected in combinations suitable to the application and the nature of a desired bonding for which the adhesive tape strip 12 is intended.

It should be understood, of course, that the foregoing relates to exemplary embodiments of the invention and that modifications may be made without departing from the spirit and scope of the invention as set forth in the following claims.

What is claimed is:

1. An adhesive tape, comprising:
a backing material;
an adhesive applied to the backing material of a body of each strip leaving a small portion of approximate 2% free of adhesive at an end of each strip to form an end locator;
a perforation of the backing material between each strip, each perforation defining a strip; and
a core for retaining the backing material in a rolled configuration.

2. The adhesive tape of claim 1, wherein the perforation is defined at a uniform spacing along a longitudinal length of the backing material.

3. The adhesive tape of claim 1, wherein the perforation is defined at a predetermined spacing along a longitudinal length of the backing material.

4. The adhesive tape of claim 1, wherein the perforation is defined between a preceding strip and a subsequent strip.

5. The adhesive tape of claim 1, wherein the end locator is defined at a leading end of each strip.

6. The adhesive tape of claim 1, wherein the end locator is defined at a trailing end of each strip.

7. The adhesive tape of claim 3, wherein the perforation is defined at a uniform spacing along the longitudinal length of the backing material.

8. The adhesive tape of claim 3, wherein the perforation is defined at a predetermined spacing along the longitudinal length of the backing material.

9. The adhesive tape of claim 8, wherein the perforation is defined between a preceding strip and a subsequent strip.

10. The adhesive tape of claim 9, wherein the end locator of the subsequent strip is defined at a terminal end of the preceding strip.
